(19) United States
(12) Patent Application Publication
(10) Pub. No.: US 2015/0025781 A1
(43) Pub. Date: Jan. 22, 2015

(54) CANISTER PURGE VALVE LEAK DETECTION SYSTEM

(71) Applicant: FORD GLOBAL TECHNOLOGIES, LLC, Dearborn, MI (US)

(72) Inventors: RUSSELL RANDALL PEARCE, ANN ARBOR, MI (US); DENNIS SEUNG-MAN YANG, CANTON, MI (US); AED M. DUDAR, CANTON, MI (US)

(21) Appl. No.: 13/944,902

(22) Filed: Jul. 18, 2013

(51) Int. Cl. F02D 41/22

(52) U.S. Cl. CPC F02D 41/22
USPC 701/114

(57) ABSTRACT

System for detecting leakage within a canister purge valve of an evaporative emission control system. The system includes a power train control module connected to the canister purge valve, configured to command the canister purge valve between open and closed positions. In addition, the system includes a flow meter having an inlet and an outlet. The inlet is in fluid communication with ambient air surrounding the vehicle, and the outlet is in fluid communication with an inlet of the canister purge valve. The system further includes a control module operatively connected to the flow meter. The control module is programmed to analyze flow through the flow meter; compare the measured flow to predetermined flow data; and to indicate whether that flow exceeds a predetermined level.

### TECHNICAL FIELD

Embodiments of the present disclosure generally relate to evaporative emission control systems for automotive vehicles, and, more specifically, to Canister Purge Valves (CPVs) of such systems.

### BACKGROUND

Evaporative emission control (EVAP) systems are installed in many modern automotive vehicles to prevent fuel vapor from being discharged into the. Fuel in a fuel tank naturally evaporates, and the resulting vapor may escape to the atmosphere, causing air pollution. In EVAP systems, canisters containing absorbent carbon (“carbon canisters”) are connected to the fuel tank to adsorb such vapor before it can be discharged. A canister purge valve (CPV) is positioned in a communication line between the carbon canister and the engine intake manifold. Another fluid communication line connects the carbon canister to the open atmosphere. When the engine operates, the CPV can be opened, so that air flows through the carbon canister, where it entrains fuel vapor. The air/vapor mixture proceeds through the intake manifold into the engine, where the fuel vapor is combusted.

The CPV is an integral component of a vehicle's EVAP system. The valve is normally closed, allowing fuel vapor to be adsorbed in the carbon canister. When the CPV is open, air flows through the carbon canister, in training and removing the adsorbed fuel vapor. The separation is referred to as purging the canister. Generally, the CPV is a solenoid valve controlled by the power train control module or the engine control module of the vehicle.

CPVs can be a major cause of leaks in evaporative emission control systems such leaks can cause a number of problems, such as clogging the valve or preventing the recycling of the fuel vapor from the fuel tank. A leaky CPV can also cause material damage to the fuel tank. A typical EVAP leak detection system uses engine vacuum to evacuate the fuel tank, and then it shuts off vacuum and monitors for vacuum bleedups. If the CPV is leaky, the system may act as though it had shut off vacuum, but in reality the leaky CPV will continue to pull down the fuel tank until it is compromised. Indeed, damaged fuel tanks are a symptom of a leaky CPV. Such problems can affect performance and can also lead to a customer dissatisfaction and warranty claims

Also, CPV problems are difficult to detect during the manufacturing process. For example, it would be useful to be able to test the CPV with the engine running during the manufacturing process, but tests at this stage are limited to determining whether the CPV is stuck open or closed. Small leaks may thus avoid detection until the automobile is in the customer's hands.

Considering the problems mentioned above, and other shortcomings in the art, there exists a need for a more efficient and effective system and method for testing CPV leakage during the automotive manufacturing process.

### SUMMARY

The present disclosure provides an efficient system for testing a CPV for leaks in an automotive evaporative emission control system.

According to an aspect of the disclosure, the present disclosure provides a system A system for detecting leakage within a canister purge valve of an evaporative emission control system of an automotive vehicle, in which the canister purge valve includes an outlet in fluid communication with the engine intake manifold. The system comprises, first, a power train control module connected to the canister purge valve, configured to command the canister purge valve between_open and closed positions. In addition, the system includes a flow meter having an inlet and an outlet. The inlet is in fluid communication with ambient air surrounding the vehicle, and the outlet is in fluid communication with an inlet of the canister purge valve. The system further includes a control module operatively connected to the flow meter. The control module is programmed to analyze flow through the flow meter; compare the measured flow to predetermined flow data; and to indicate whether that flow exceeds a predetermined level.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1.is a schematic diagram representing an exemplary system for testing leakage within a Canister Purge Valve (CPV) connected to an engine's intake manifold, according to an embodiment of the present disclosure.

FIG. 2a and FIG. 2b are flowcharts depicting the different steps involved in a method for detecting leakage within a canister purge valve, according to an embodiment of the present disclosure.

FIG. 3 is a regression curve generated to predict the size of a leak within the CPV, as a function of the volumetric flow rate through a flow meter connected to the load side of the CPV, according to an embodiment of the present disclosure.

### DETAILED DESCRIPTION OF ILLUSTRATIVE EMBODIMENTS

The following detailed description illustrates aspects of the disclosure and its implementation. This description should not be understood as defining or limiting the scope of the present disclosure, however, such definition or limitation being solely contained in the claims appended thereto. Although the best mode of carrying out the invention has been disclosed, those in the art would recognize that other embodiments for carrying out or practicing the invention are also possible.

A canister purge valve (CPV) allows fuel vapor captured in a carbon canister to flow from the canister to the engine intake manifold, where the vapor is combusted. This action completes the cycle of capturing vapor, entraining that vapor in an airflow, and directing that airflow into the intake manifold, preventing vapor from escaping into the environment and causing pollution. Positioned between the engine's intake manifold and the carbon canister, the input of the CPV is connected to the output of the canister, and its output is directly connected to the intake manifold.

Any leakage present within the CPV may allow fuel vapor to escape and pollute the environment. Air quality authorities in certain regions, such as California, require less than about 500 mg of vehicle evaporative emissions. Certain other regulations, such as the PZEV regulations that are a part of zero emission vehicles in California, for promoting fuel cell vehicles and electric vehicles, require less than about 350 mg of net vehicle emissions and zero emissions from the fuel-system of the vehicle. The Euro 5/6 regulation prescribed for the EU member states enforce a limit of about 2 grams of evaporative emissions per day. To meet such standards, the EVAP system must perform correctly, which in turn requires preventing CPV leaks.

A CPV received from a supplier may leak, which can cause functional problems in the EVAP systems, along with causing pollution. Further, detecting minute leakage within a CPV is difficult, especially after the valve has been assembled in the EVAP system.

The present disclosure provides a system and method for testing leakage in CPVs for the EVAP systems of automotive vehicles. The leakage testing is performed during engine assembly, and thus any problems can be corrected before the automobile reaches the customer.

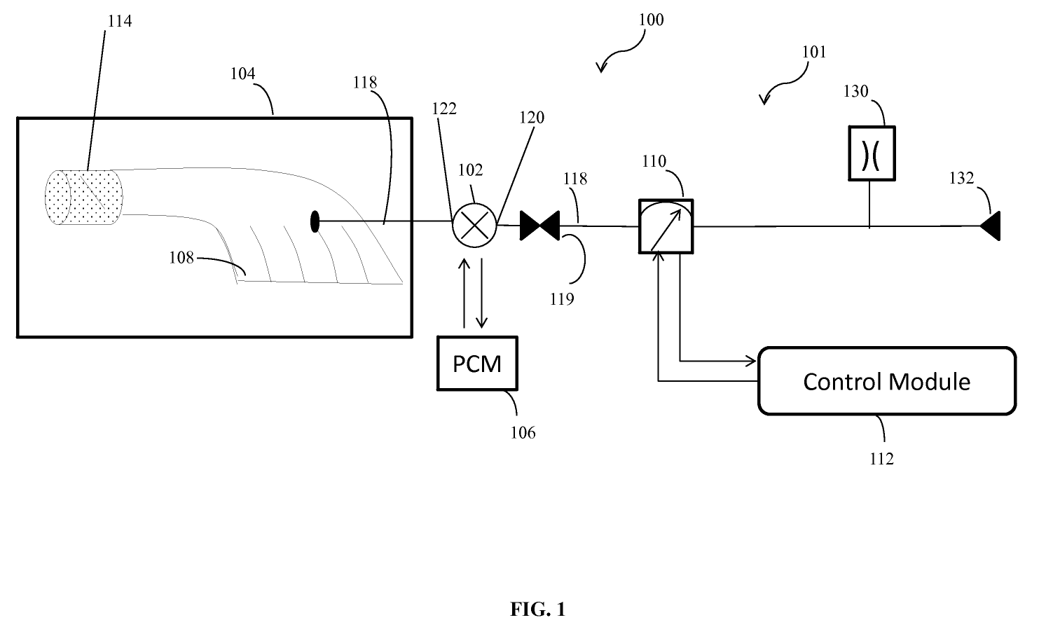

FIG. 1 is a schematic view of an EVAP system 100, including a system 101 for testing leakage within a CPV 102. In normal operation, the EVAP system includes a carbon canister (not shown), connected via fluid flow lines to the fuel tank (not shown), to ambient atmosphere, and to the CPV 102. The CPV 102 includes an inlet 120, normally connected to the carbon canister, and an outlet 122, connected via a fluid flow line 118 to the engine intake manifold 108 of engine 104.

A power train control module (PCM) 106 is coupled to CPV 102. In normal operation, this module performs a number of important functions in controlling the automobile's powertrain, including engine 104, and one of those functions is controlling the CPV 102. Normally, the CPV 102 remains closed, preventing any flow from the canister to intake manifold 108. During that period, the activated carbon within canister adsorbs fuel vapor. When the system is prepared to purge fuel vapor from canister, PCM 106 opens CPV 102, allowing air to flow from the ambient atmosphere through canister, where it entrains fuel vapor. The air/fuel mixture passes through CPV 102 and into intake manifold 108, from which it enters engine 104 to be combusted.

The present disclosure substitutes leakage test system 101 for the portion of the EVAP system that includes the canister and associated components. The leakage test system 101 can be brought into close proximity to the system under test, and it can then be plugged into that system using quick disconnect 119. In place of the carbon canister, this system includes a communication line 118, flow meter 110, a control module 112, an orifice adapter 130, and an atmosphere valve 132. Flowmeter 110 is a standard component for measuring a volumetric flow rate and outputting a signal indicating that flow rate. That signal is communicated to control module 112 which compares that flow rate to a data set that associates flow rates with leak sizes. The assembly of that data set, as well as the process for employing that data set, is set out in detail below.

It should be noted that control module 112 can be embodied in a specially-constructed test instrument, or it can be embodied in software or firmware, operable on a computing device, such as a laptop, a PDA, or a larger computing device operable in the test facility where the testing is being conducted. Those of skill in the art will understand the well-known techniques for implementing the specific algorithms required both to assemble the data set noted above and to employ that data in analyzing leakage, based upon the functional requirements set out below.

As generally noted above, and more specifically discussed below, the system assembles a data set associating a given leak size with a particular flow rate. Such a data set must be assembled for each variation in CPV type or the like.

To collect data associating flow rates with leak sizes, an orifice adapter 130 is provided, located upstream of the flowmeter 110. This device will accept orifices of a known size, so that if the CPV 102 is open and atmosphere valve 132 is closed, then imposition of a vacuum at intake manifold 108 will produce a flow through the orifice adapter 130 and CPV 102. Clearly, that flow will be identical to the flow that would be seen in the presence of a leak having the same size as the particular orifice inserted into orifice adapter 130. By assembling a data set obtained from a set of orifices, ranging from the smallest expected leak to the largest, one can assemble data associating a range of leak sizes to the flow rates produced by those leaks. The data set can be provided in the form of a lookup table or similar memory device, allowing control module 112 to match an experienced flow level with a calibrated leak size.

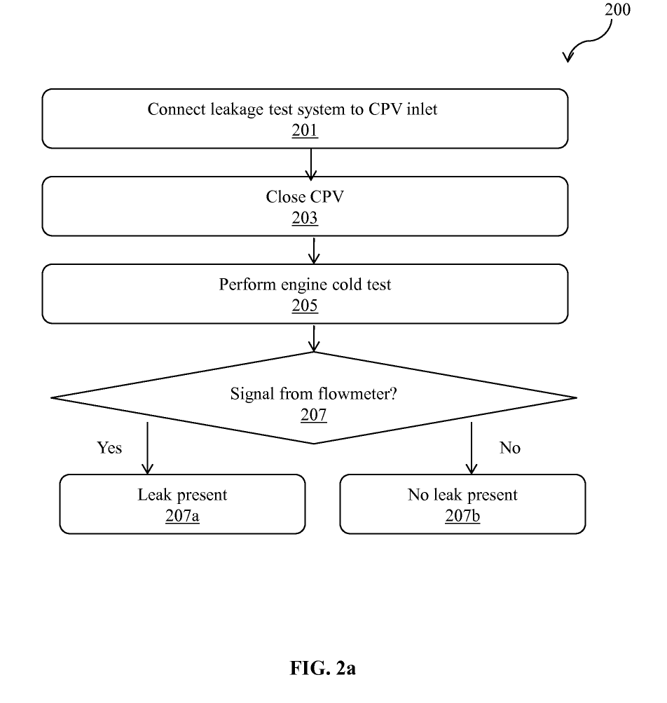

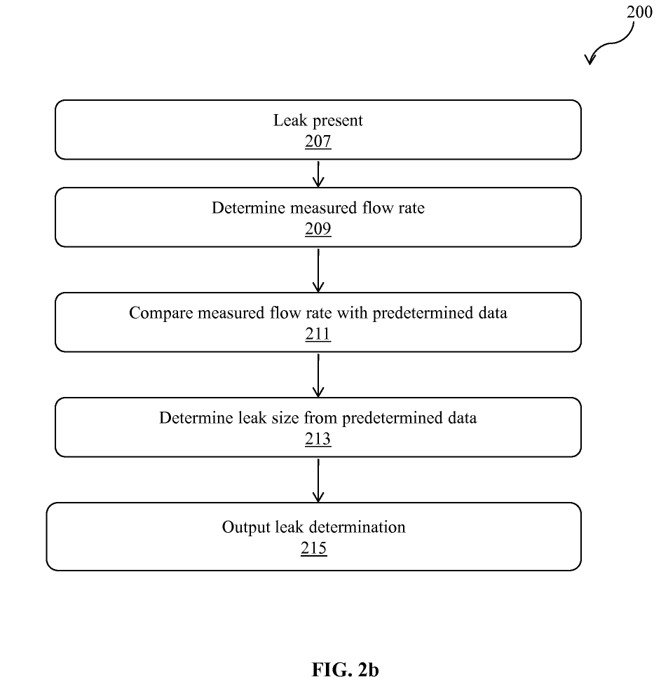

FIGS. 2a and 2b are the flowcharts 200 illustrating a method for detecting leakage and calculating the size of the leak within a CPV 102 of an EVAP system of a vehicle, according to an embodiment of the present disclosure

Initially, as noted above, leakage test system 101 is connected to CPV 102 inlet at quick disconnect 119 at step 201. That action removes the carbon canister and associated components from the flow path upstream of the CPV 102. Next, at step 203, the PCM 106 commands the CPV 12 to close, while simultaneously opening atmosphere air valve 132. In some embodiments, atmosphere air valve 132 may be permanently open, in which case no action need be taken with that component during this step. Then, the engine cold test is performed at step 205. This step consists of operating the engine by turning the flywheel with a dynamometer or the like. Primarily, the pistons create a vacuum on their downstroke, imposing a vacuum at intake manifold 108, which vacuum is also applied to the output side of CPV 102.

A properly operating CPV should completely block the flow at this point. Thus, if step 207 results in a signal being received from flowmeter 110 indicating some flow, then a leak of some size must be present, as shown in block 207a. Zero flow, or a flow below predetermined levels, as shown at block 207b, indicates that the CPV 102 is acceptable, and also indicates the end of the test.

FIG. 2b illustrates the process for analyzing the signal obtained from flow rate 110 in the event that a leak is present at block 207. As can be seen with reference to FIG. 1, the actions shown here are performed in control module 112 after receiving a signal from flowmeter 110. At step 209, control module 112 processes the signal received from flowmeter 110 to determine the measured flow rate. Next, at step 211, control module 112 compares that flow rate with the predetermined data set to identify the relevant data within the collected data set. Dedicated memory within control module 112 can be provided for this purpose, or the system can make use of other data resources within the testing facility. From the predetermined data set, as more fully shown below, control module 112 can determine a leak size that corresponds to the observed flow rate, at step 213.

Here, it should be noted that the observed flow rate takes into account the cumulative flow from all leaks. For example, an accumulation of contaminants within the valve seat of CPV 102 could result in several leaks being present. The total flow rate measured by flowmeter 110 in that instance would be the total flow produced by all of those leaks taken together. In “Green States,” which follow the standards set out by the California Air Resources Board,” the sum of all leaks cannot exceed the flow produced by a leak 0.02″ in diameter. A typical EVAP system can have 0.005″ inherent leakage, so even a very small additional leak can exceed the leakage standard.

Control module 112 then characterizes the leak, based on predetermined acceptability data, and outputs a leak determination to an operator, at step 215. The output techniques employed can be selected from among the various well-known methods available to the art. In one embodiment, employing a laptop computer as the control module 112, a warning message is triggered for display on that device's screen. In a more automated system, an audible warning may be sounded, indicating a defect condition. In any event, the engine under test is pulled off the line for further processing.

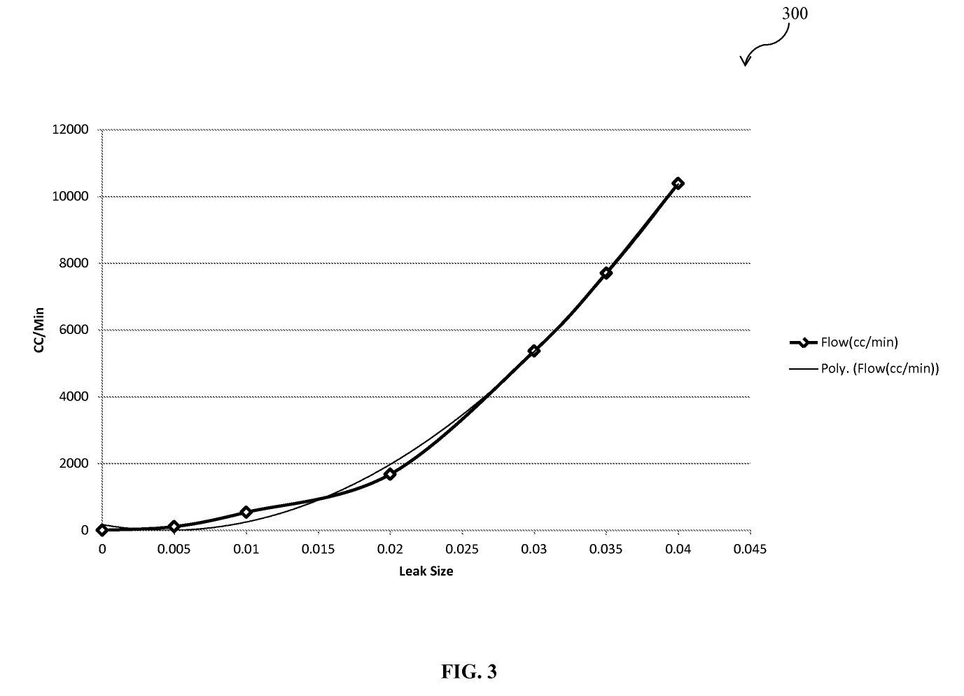

FIG. 3 is a regression curve 300, generated to display the leakage orifice size within of CPV 102, as a function of the volumetric flow rate measured by flow meter 110. A family of data sets underlying such curves must be assembled, reflecting the various Injun configurations underproduction, and the test data in use must correspond to that particular engine. Each particular engine will have an associated suction applied to the intake manifold. In one embodiment, that suction is about 70 kPa of suction

Known regression curve fitting techniques may be used to interpolate the curve, once certain specific values of the leakage orifice size as a function of the flow rate are known. As is seen, with the flow rate being plotted over the y-axis and represented as y(x) (y being in cc/min.), where x represents the leakage orifice size in inches, the flow rate reading through the flow meter parabolically increase. The parabolic regression curve equation is found as:

Y(x)=8E+0.6x²−74686x++172.36 (1)

Using the regression Eq. (1) above, the leakage size of the CPV can be identified for any value of volumetric flow rate noted at the flow meter connected to the CPV.

The method and the system of the present disclosure can be used for detecting a wide size range of leakage ports within the CPVs of the Evaporative Emission Control Systems, and can be easily used to conduct testing at the engine cold test stations, thus, overcoming the limitations in testing CPVs at the assembly lines, such as the cycle time constraints. Further, the method is simple and easy to carry out, is efficient, and does not require the engine to be refueled.

Although the current invention has been described comprehensively, in considerable details to cover the possible aspects and embodiments, those skilled in the art would recognize that other versions of the invention are also possible.

What is claimed is:

1. A system for detecting leakage within a canister purge valve of an evaporative emission control system of an automotive vehicle, the canister purge valve having an outlet in fluid communication with the engine intake manifold, the system comprising:
a power train control module connected to the canister purge valve, configured to command the canister purge valve between_open and closed positions;
a flow meter having an inlet in fluid communication with ambient air surrounding the vehicle, and an outlet in fluid communication with an inlet of the canister purge valve; and
a control module operatively connected to the flow meter and configured for
analyzing flow through the flow meter;
comparing the flow to predetermined flow data;
indicating whether the flow exceeds a predetermined level.

2. The system of claim 1, further comprising an orifice adapter positioned upstream of the flow meter, the orifice adapter including one or more orifices, each having a preselected diameter.

3. The system of claim 1, being further configured to detect the size of the leaking region within the canister purge valve, based on the flow rate of the ambient air flowing through the flow meter and entering the system.

4. The system of claim 1, being further configured to detect a leaking region within the canister purge valve, based on the flow rate of the ambient air flowing through the flow meter and entering the system, the leaking region having a minimum size of 0.002 in.²

5. The system of claim 1, further comprising a quick-disconnect connector positioned between the canister purge valve and a carbon canister, the quick-disconnect connector being adapted for connection to the flow meter.

6. The system of claim 1, wherein the canister purge valve is mounted on an automotive engine, in fluid communication with the automotive engine intake manifold.

7. The system of claim 1, wherein the system is adapted to detect leakage during an engine cold test.

8. A system for calibrating a leakage detection system operating in conjunction with a canister purge valve of an evaporative emission control system of an automotive vehicle, the canister purge valve having an outlet in fluid communication with the engine intake manifold, the system comprising:
a power train control module connected to the canister purge valve, configured to command the canister purge valve between_open and closed positions;
a flow meter having an inlet in fluid communication with ambient air surrounding the vehicle, and an outlet in fluid communication with an inlet of the canister purge valve;
an orifice adapter positioned upstream of the flow meter, the orifice adapter including one or more orifices, each having a preselected diameter; and
a control module operatively connected to the flow meter and configured for
analyzing flow through the flow meter;
comparing the flow to predetermined flow data;
indicating whether the flow exceeds a predetermined level.

9. The system of claim 8, being further configured to detect the size of the leaking region within the canister purge valve, based on the flow rate of the ambient air flowing through the flow meter and entering the system.

10. The system of claim 8, wherein the orifice adapter includes an orifice having a minimum size of 0.002 in.²
